(19) United States
(12) Patent Application Publication
(10) Pub. No.: US 2022/0293017 A1
(43) Pub. Date: Sep. 15, 2022

(54) FLEXIBLE LED SCREEN

(71) Applicant: INFINIA MÜHENDISLIK LTD. STI., Istanbul (TR)

(72) Inventors: Ísmail Tugay GÜZEL, Istanbul (TR); Kadem Berker YASAR, Istanbul (TR)

(73) Assignee: INFINIA MÜHENDISLIK LTD. STI., Istanbul (TR)

(21) Appl. No.: 17/633,339

(22) PCT Filed: Jul. 27, 2020
(86) PCT No.: PCT/TR2020/050659

§ 371 Date: Feb. 7, 2022

(30) Foreign Application Priority Data
Aug. 9, 2019 (TR) 2019/12248

(51) Int. Cl. G09F 9/30; G09G 3/00; G09F 9/302

(52) U.S. Cl. CPC G09F 9/301; G09G 3/035; G09F 9/3026; G09G 2370/12; G09G 2300/026

(57) ABSTRACT

The invention relates to a flexible LED screen that is employed in indoor and outdoor spaces for various purposes, and that is produced by using materials and technique that allow reducing the number of components in its structure and will be applied for the first time in this field, and that, therefore, allows creating a lighter and more flexible structure compared to the products manufactured with the current technique, and that enables decreasing malfunction and error rates through reduction of the number of components in its structure thanks to the materials and technique used in its manufacture.

### TECHNICAL FIELD

The invention relates to a flexible LED screen that is employed in indoor and outdoor spaces for various purposes, and that is produced by using materials and technique that allow reducing the number of components in its structure and will be applied for the first time in this field, and that, therefore, allows creating a lighter and more flexible structure compared to the products manufactured with the current technique, and that enables decreasing malfunction and error rates through reduction of the number of components in its structure thanks to the materials and technique used in its production.

### BACKGROUND

Today, various display devices are used in indoor and outdoor spaces for different purposes such as advertisement, promotion, information, and guidance, and flexible LED screens are one of the most widespread display means. Current flexible LED screens contain too many components due to their structures, and as a result, their flexibility is reduced, they become heavy, and the rate of occurrence of malfunction and error increases due to the high number of components on the screen.

There are some endeavors in this field, and the Turkish patent application numbered TR 2019/05964 mentions a “flexible LED module structuring for LED display systems”, and it states that the concerned product relates to a flexible LED module structuring for LED display systems to be used in the manufacture of LED display devices for non-planar application surfaces.

The PCT application numbered WO2013023559A1 describes a product titled “Hanging flexible LED display screen”, and it is stated that the product comprises a flexible hanging LED display screen and a few spaced LED modules and flexible mesh, and that the LED module is fixed on the flexible mesh in matrix form, and that adjacent LED modules are equally distanced and are positioned transversely and longitudinally, and that the product is more permeable and is more resistant against wind compared to fixed and rigid box structure, and that these discrete structures are easy to be fixed on the mesh with the LED module and are quickly installed, and that each individual module is repaired or replaced more easily when damaged, and that this display screen is low cost and its manufacture process is short.

In conclusion, the need to eliminate the shortcomings and disadvantages of the existing structures and embodiments of the current technique has necessitated a development in the relevant technical field.

### AIM OF THE INVENTION

The present invention relates to a flexible LED screen that is developed to resolve the above-mentioned disadvantages and provide new advantages to the concerned technical field.

The aim of the invention is to ensure the development of a structure in which the addressable LEDs are used in screen structure, unlike the conventional structuring of the products available in the current technique.

Another aim of the invention is to eliminate the need to use extra components for screen structure thanks to the creation of a screen structure using addressable LEDs.

Another aim of the invention is to present a lighter product with higher flexibility compared to the products manufactured with the current technique thanks to the elimination of the need to use extra components for screen structure.

Another aim of the invention is to reduce the risk of malfunction and error to a minimum thanks to the elimination of the need to use extra components for screen structure.

Another aim of the invention is to facilitate and simplify installment procedures and to lower costs thanks to the development of a lighter product with higher flexibility as opposed to the products manufactured with the current technique and the building of a structure with less components.

Another aim of the invention is to enable the emergence of new areas of use of LED screens compared to LED displays manufactured with the prior technique, thanks to its flexibility.

Another aim of the invention is to digitalize various means of promotion such as roll-ups, billboards, advertisement brochures, tarpaulins, banners, etc. that are created with visual printing method to be used in advertising, marketing, organization, and other similar fields by producing them with flexible LED screens.

Structural and characteristic features of the invention, as well as all of its advantages, will be understood more clearly with the figures given below and the detailed description written by referring to the relevant figures, and therefore, the evaluation should be made by taking into consideration of the said figures and detailed description.

### DETAILED DESCRIPTION OF THE INVENTION

Alternatives selected for this detailed description of the flexible LED screen subject to the invention are described only to ensure a better understanding of the subject and in a way that will not create any limiting impact.

The invention relates to a flexible LED screen that is employed in indoor and outdoor spaces for various purposes such as advertisement, promotion, information and guidance, and that allows reducing the number of components in its structure, and that, therefore, enables creating a lighter and more flexible structure compared to the products manufactured with the current technique, and that ensures decreasing malfunction and error rates through reduction of the number of components in its structure.

The product subject to the invention includes the following in general: minimum one modular screen that comprises addressable LEDs to ensure building a lighter structure with higher flexibility compared to the screens manufactured with the current technique by allowing the generation of image without needing extra components, minimum one HDMI vision sensing module to convert the incoming HDMI video signal to parallel digital video format so that the video data can be processed with digital circuits, minimum one electronic module to convert digital video data from the HDMI vision sensing module into serial video data suitable to be sent to addressable LEDs, and minimum one control card with minimum one buffer driver module to drive digital video signals on the electronic module output to the screen composed of addressable LEDs by increasing the relevant digital video signals to the desired voltage logic level.

Having a modular structure, the screen comprises modules that are linked to each other from four edges with various mechanical methods, and it is possible to create a screen at a desired size. The control card automatically adjusts image format so that it can adapt to screens of any size.

1. The invention is a flexible LED screen that is employed in indoor and outdoor spaces for various purposes such as advertisement, promotion, information and guidance, and that allows reducing the number of components in its structure, and that, therefore, enables creating a lighter and more flexible structure compared to the products manufactured with the current technique, and that ensures decreasing malfunction and error rates through reduction of the number of components in its structure, and its feature is that it includes
minimum one modular screen that comprises addressable LEDs to ensure building a lighter structure with higher flexibility compared to the screens manufactured with the current technique by allowing the generation of image without needing extra component,
minimum one HDMI vision sensing module to convert the incoming HDMI video signal to parallel digital video format so that the video data can be processed with digital circuits, minimum one electronic module to convert digital video data from the HDMI vision sensing module into serial video data suitable to be sent to addressable LEDs, and minimum one control card with minimum one buffer driver module to drive digital video signals on the electronic module output to the screen composed of addressable LEDs by increasing the relevant digital video signals to the desired voltage logic level.
